(19) United States
(12) Patent Application Publication
(10) Pub. No.: US 2021/0075851 A1
(43) Pub. Date: Mar. 11, 2021

(54) APPLICATION PARTITION PROCESSING METHOD, DEVICE, AND COMPUTER-READABLE STORAGE MEDIUM

(71) Applicant: SHANGHAI ZHANGMEN SCIENCE AND TECHNOLOGY CO., LTD., Shanghai (CN)

(72) Inventors: Dan LIAO, Shanghai (CN); Zhibin LING, Shanghai (CN)

(73) Assignee: SHANGHAI ZHANGMEN SCIENCE AND TECHNOLOGY CO., LTD., Shanghai (CN)

(21) Appl. No.: 17/099,131

(22) Filed: Nov. 16, 2020

Related U.S. Application Data
(63) Continuation of application No. PCT/CN2018/124526, filed on Dec. 27, 2018.

(30) Foreign Application Priority Data
May 14, 2018 (CN) 201810455846.2

(51) Int. Cl. H04L 29/08; G06F 9/54; H04W 4/021

(52) U.S. Cl. CPC H04L 67/10; H04W 84/12; H04W 4/021; G06F 9/547

(57) ABSTRACT

An application partition processing method, a device, and a computer-readable storage medium is provided. In embodiments of the present application, an application component obtains location information of a user from a first application, and then obtains an application partition of the user in a second application according to the location information of the user, so that the application component associates the user to the application partition and implementing the application partition of the user.

### CROSS REFERENCE TO THE RELATED APPLICATIONS

This application is the continuation application of International Application No. PCT/CN2018/124526, filed on Dec. 27, 2018, which is based upon and claims priority to Chinese Patent Application No. 201810455846.2, filed on May 14, 2018, the entire contents of which are incorporated herein by reference.

### TECHNICAL FIELD

The present application relates to Internet technologies, and in particular, to an application partition processing method, a device, and a computer-readable storage medium.

### BACKGROUND

With the development of communication technologies, a terminal integrates increasing functions, so that a system function list of the terminal includes more corresponding applications (APPs), such as game applications. To prevent application servers from crashing due to a large amount of user access to an application, and improve an access speed of the user access to the application, users of the application may be randomly divided into different application partitions, or the users actively select an application partition. An application server corresponding to each application partition provides application services for users of the application partition, to allow the users access the application.

However, due to the randomness of the existing application partitioning, in some cases, for example, most users select the same application partition. Consequently, the purpose of the application partitions may not be achieved, resulting in a decrease in the reliability of the application partitions.

### SUMMARY

A plurality of aspects of the present application provide an application partition processing method, a device, a computer-readable storage medium, to improve the reliability of application partitions.

According to an aspect of the present application, an application partition processing method is provided, including:

obtaining, by an application component, location information of a user from a first application;

obtaining, by the application component, an application partition of the user in a second application according to the location information of the user; and

associating, by the application component, the user to the application partition.

According to another aspect of the present application, a device is provided, including:

one or more processors; and

a storage apparatus, configured to store one or more programs,

where the one or more programs, when executed by the one or more processors, cause the one or more processors to perform the application partition processing method according to the foregoing aspect.

According to another aspect of the present application, a computer-readable storage medium is provided, storing a computer program, where the application partition processing method according to the foregoing aspect is performed when the program is executed by a processor.

It may be learned from the foregoing technical solutions that in the embodiments of the present application, an application component obtains location information of a user from a first application, and then obtains an application partition of the user in a second application according to the location information of the user, so that the application component may associate the user to the application partition, thereby implementing the application partition of the user.

In addition, by using the technical solutions provided in the present application, the application component and the second application are independent of each other, so that the application component is portable and may be conveniently applied to the second application, thereby improving the universality of running of the application component.

In addition, by using the technical solutions provided in the present application, the application component and the second application are independent of each other, so that the application component can implement application partitions of users for different second applications, and it is unnecessary to configure an application component independently for each second application, thereby effectively reducing development costs of the second application.

In addition, by using the technical solutions provided in the present application, the application component and the second application are independent of each other, so that the application component can implement application partitions of users for different second applications, set different application partitioning methods for different second applications, and guide user traffic into the application partitions.

In addition, by using the technical solutions provided in the present application, users are allocated to different application partitions, so that the users obtain better user experience. For example, offline interaction relationships are transplanted to online interactions (people familiar with each other in the same place can play games together). Alternatively, in another example, offline interactions are developed through online geographic relevance (nearby people unfamiliar with each other may communicate offline by playing games), to enhance online and offline social experience of the users, and improve user experience of games or applications having social and multi-person interaction attributes, such as board games, and team battle games.

### BRIEF DESCRIPTION OF THE DRAWINGS

To describe the technical solutions in the embodiments of the present application more clearly, the following briefly describes accompanying drawings required for describing the embodiments or the existing technology. Apparently, the accompanying drawings in the following description show some embodiments of the present application, and a person of ordinary skill in the art may still derive other drawings from these accompanying drawings without creative efforts.

FIG. 1 is a schematic flowchart of an application partition processing method according to an embodiment of the present application.

FIG. 2 is a block diagram of an example of a computer system/server 12 suitable for implementation of the present application.

### DETAILED DESCRIPTION OF THE EMBODIMENTS

To make the objectives, technical solutions, and advantages of the embodiments of the present application clearer, the following clearly and completely describes the technical solutions in the embodiments of the present application with reference to the accompanying drawings in the embodiments of the present application. Apparently, the described embodiments are merely some embodiments of the present application rather than all of the embodiments.

All other embodiments obtained by a person of ordinary skill in the art based on the embodiments of the present application without creative efforts shall fall within the protection scope of the present application.

It should be noted that, a terminal in the embodiments of the present application may include, but is not limited to a mobile phone, a personal digital assistant (PDA), a wireless handheld device, a tablet computer, a personal computer (PC), a MP3 player, a MP4 player, a wearable device (for example, smart glasses, a smart watch, a smart band) or the like.

In addition, the term “and/or” in this specification describes only an association relationship for describing associated objects and represents that three relationships may exist. For example, A and/or B may represent the following three cases: only A exists, both A and B exist, and only B exists. In addition, the character “/” in this specification generally indicates an “or” relationship between the associated objects.

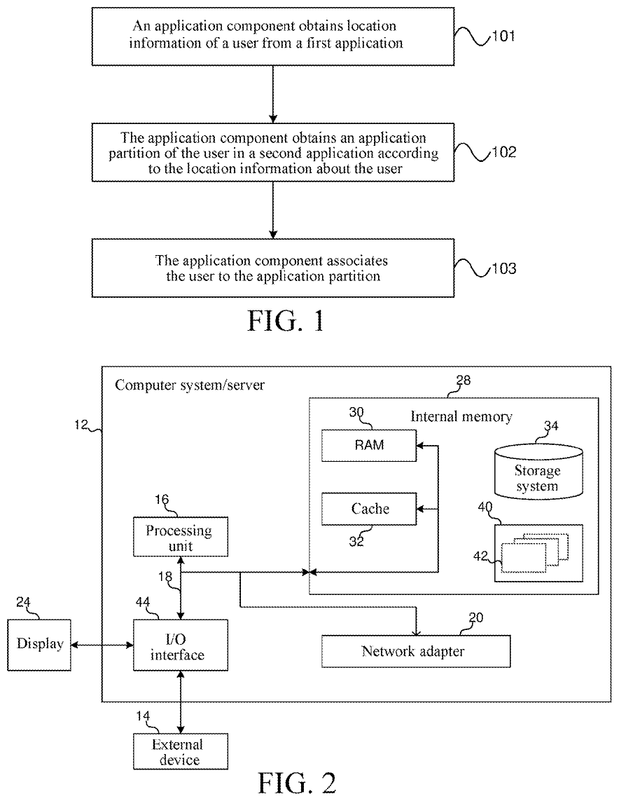

FIG. 1 is a schematic flowchart of an application partition processing method according to an embodiment of the present application. As shown in FIG. 1, the method includes the following steps:

101: An application component obtains location information of a user from a first application.

102: The application component obtains an application partition of the user in a second application according to the location information of the user.

The second application is generally an application in which application partitions need to be set, such as a game application, or another application having interactive and social attributes. This is not particularly limited in this embodiment.

103: The application component associates the user to the application partition.

It should be noted that 101 to 103 may be all or partly executed by an application located on a local terminal, or a function unit such as a plug-in or a software development kit (KIT), or the like located in the application of the local terminal, or a partition platform located in a server on a network side, or a distributed system located on the network side. This is not particularly limited in this embodiment.

It may be understood that an application in the local terminal may be a native app installed on the terminal, or may be a web app in a browser on the terminal. This is not limited in this embodiment.

In this way, the application component obtains the location information of the user from the first application, and then obtains the application partition of the user in the second application according to the location information of the user, so that the application component may associate the user to the application partition, thereby implementing the application partition of the user.

In the present application, the application component is independent of the second application, or may be integrated with the second application. This is not limited in this embodiment.

In the present application, the first application and the second application are simultaneously loaded in the terminal. The first application may be independent of the second application, or may be integrated with the second application, or may be a host application such as a WeChat application. Correspondingly, the second application may be a hosted application hosted in the first application. This is not particularly limited in this embodiment.

Optionally, in a possible implementation of this embodiment, the first application and the second application may be two associated applications having an association relationship.

In a specific implementation process, the first application and the second application may share user information. For example, for a target user A, if an account of the user in the first application is userA, the user may directly log in to the second application through userA.

In another specific implementation process, user information in the first application and the second application may be associated with each other. For example, for a target user B, if an account of the user in the first application is userB, the user may directly log in to the second application through userB′ associated with userB.

In another specific implementation process, the first application may specifically obtain an invoking instruction triggered by the user for the second application, so that the first application may trigger running of the second application according to the invoking instruction.

In the implementation process, the first application, after outputting an icon of the second application, may further obtain the invoking instruction, which is triggered by the user based on an operation on the icon of the second application, for the second application.

The operation includes an operation gesture. The operation gesture may include, but is not limited to at least one of the following operation gestures:

an operation gesture of the user on the icon of the second application;

a hover operation gesture of the user above a page where the icon of the second application is located;

a contact operation gesture of the user on the page where the icon of the second application is located; and

a motion trend of driving a terminal by the user based on the page where the icon of the second application is located.

The operation gesture of the user on the icon of the second application may refer to a user operation of, for example, clicking the icon of the second application displayed by a display apparatus of an operation terminal. The clicking operation may be a trigger operation performed by the user by controlling a cursor with an external input device such as a mouse or keyboard, or may be a touch operation performed by the user by touching an input device with a finger or a stylus. This is not particularly limited in this embodiment.

The hover operation gesture of the user above the page where the icon of the second application is located may refer to a hover sliding track, which is above the page where the icon of the second application is located displayed by a display apparatus of a terminal, of the user within a capture range of an image sensor of the terminal. The image sensor may be a charge coupled device (CCD) sensor, or may be a complementary metal-oxide semiconductor (CMOS) sensor. This is not particularly limited in this embodiment. The hover sliding track may include, but is not limited to, a straight line or a curve in any shape formed by a plurality of stay points corresponding to a plurality of continuous sliding events. This is not particularly limited in this embodiment.

The contact operation gesture of the user on the page where the icon of the second application is located may refer to a contact sliding track of the user on the page where the icon of the second application is located displayed by a display apparatus of a terminal. Generally, a terminal may be classified as a touch terminal or a non-touch terminal according to whether a display apparatus has a touch feature. Specifically, a contact operation gesture of the user on the page where the icon of the second application is located displayed by a touchscreen of a touch terminal may be specifically detected. The contact sliding track may include, but is not limited to a straight line or a curve in any shape formed by a plurality of touch points corresponding to a plurality of continuous touch events. This is not particularly limited in this embodiment. For example, the contact sliding gesture may be a long-press operation gesture of the user in a middle region of the page where the icon of the second application is located.

The motion trend of driving a terminal by the user based on the page where the icon of the second application is located may refer to a motion track, such as a shaking track or a flipping track, of driving the terminal by the user with a hand when a display apparatus of the terminal displays the page where the icon of the second application is located.

In the implementation process, the operation gesture of the user on the page where the icon of the second application is located may be specifically detected by using a sensor device. Specifically, the sensor device may include, but is not limited to, at least one of the following: a gravity sensor, an acceleration sensor, a pressure sensor, an infrared sensor, a distance sensor, and an image sensor. This is not particularly limited in this embodiment.

The distance sensor may be an ultrasonic distance sensor, an infrared distance sensor, a laser distance sensor, or a microwave distance sensor. This is not particularly limited in this embodiment. The distance sensors belong to existing mature technologies. For detailed description, refer to the related content in the related art. Details are not described herein again.

The image sensor may be a CCD sensor, or may be a CMOS sensor. This is not particularly limited in this embodiment.

Specifically, detecting the operation gesture of the user on the page where the icon of the second application is located may specifically refer detecting a starting point, an ending point, and a track from the starting point to the ending point of the operation gesture of the user on the page where the icon of the second application is located; alternatively, orphan data corresponding to the track may be further detected.

To implement the foregoing functions, a specified operation may be further preset. The invoking instruction for the second application may be triggered according to the operation of the user based on the icon of the second application only when an obtained operation meets the preset specified operation.

For example, the obtained operation includes an operation gesture. After the operation gesture of the user based on the page where the icon of the second application is located is obtained, the operation gesture may be compared with the preset specified gesture. The invoking instruction for the second application may be triggered only when the obtained operation gesture meets the preset specified gesture.

Specifically, data of the specified gesture may be stored in a storage device of the terminal.

For example, the storage device of the terminal may be a low-speed storage device, and may be specifically a hard disk of a computer system, or a non-operational internal memory, that is, a physical memory, of a mobile phone, such as a read-only memory (ROM) and an internal memory card. This is not particularly limited in this embodiment.

Alternatively, in another example, the storage device of the terminal may be a fast storage device, and may be specifically an internal memory of a computer system, or an operational internal memory, that is, a system internal memory, of a mobile phone, such as a random access memory (RAM). This is not particularly limited in this embodiment.

Optionally, in a possible implementation of this embodiment, before 101, the first application may further obtain wireless access point information of a wireless access point to which a terminal is connected, where the first application is located at the terminal, so that the first application may obtain location information of the wireless access point based on the wireless access point information. Then, the first application may provide the location information of the wireless access point to the application component, so that the application component determines the location information of the user according to the location information of the wireless access point.

In the implementation, the wireless access point connected to the terminal may be an open wireless access point that does not require connection information, or may be a wireless access point that requires connection information. Specifically, the first application may provide the connection information to the terminal, or the connection information may be inputted by the user. This is not particularly limited in this embodiment.

For example, the first application is a Wireless Fidelity (Wi-Fi) application such as a Wi-Fi master key. The first application (which may include a client of the application and/or a corresponding server) may provide connection information, such as a password, of a connectable wireless access point to the terminal where the first application is located. The user of the terminal may select a to-be-connected wireless access point from a wireless access point list provided by an operating system or a wireless access point list provided by the first application, so that the terminal accesses a wireless local area network through the wireless access point by using the connection information of the wireless access point provided by the first application.

For the open wireless access point that does not require connection information, the user of the terminal may select a to-be-connected wireless access point from a wireless access point list provided by an operating system or a wireless access point list provided by the first application, and then directly access a wireless local area network through the wireless access point.

The wireless access point information of the wireless access point may include, but is not limited to, one of the following pieces of information:

a name of a wireless access point, such as a service set identifier (SSID), in a Wi-Fi network;

a name of a wireless access point and a signal intensity of the wireless access point;

a name of a wireless access point and a historical connection success rate of the wireless access point; or

a name of a wireless access point, a signal intensity of the wireless access point, and a historical connection success rate of the wireless access point.

In the implementation, after obtaining the wireless access point information of the wireless access point connected to the terminal where the first application is located, the first application may further send a positioning request to a positioning platform according to the wireless access point information to obtain the location information of the wireless access point.

In a specific implementation process, the application component may specifically use the location information of the wireless access point as the location information of the user.

In another specific implementation process, the application component may specifically perform location calculation processing according to the location information of the wireless access point and location information of other wireless access points detected by the terminal where the application component is located, to obtain the location information of the user.

Optionally, in a possible implementation in this embodiment, before 101, the first application may further obtain location information of the terminal where the first application is located, so that the first application may provide the location information of the terminal to the application component, and the application component determines the location information of the user according to the location information of the terminal.

In a specific implementation process, the terminal may obtain geographic location data of the terminal by specifically using a positioning technology such as a global positioning system (GPS) positioning technology, a Wi-Fi positioning technology, a base positioning technology, or a sensor positioning technology. Therefore, the terminal may provide the obtained location information of the terminal to the first application. The first application may further provide the location information of the terminal to the application component.

In this way, the application component may directly use the location information of the terminal as the location information of the user.

Optionally, in a possible implementation of this embodiment, in 102, the application component may specifically determine whether a location corresponding to the location information of the user belongs to an application partition existing in the second application.

If the location corresponding to the location information of the user does not belong to any application partition existing in the second application, the application component may create a new application partition in the second application as the application partition of the user in the second application according to the location information of the user.

Specifically, the application component may specifically create a new application partition based on the location information of the user. For example, with the location information of the user as a center, the new application partition may be a region based on a preset region range, such as a circular region with a radius of N (N is a value greater than 0), or a rectangular region with a diagonal of M (M is a value greater than 0).

If the location corresponding to the location information of the user belongs to an application partition existing in the second application, the application component may obtain an application partition existing in the second application as the application partition of the user in the second application through matching according to the location information of the user.

In a specific implementation process, if the application component determines, according to the location information of the user, an application partition existing in the second application, the application component may directly use the application partition as the application partition of the user in the second application.

In another specific implementation process, if the application component determines, according to the location information of the user, that two or more application partitions existing in the second application covering the location information of the user, the application component may further obtain an application partition as the application partition of the user in the second application through matching according to a current density of each application partition in the at least two application partitions.

The current density of the application partition refers to a user density in a region of the application partition, for example, a player density in an application lobby of a game application.

For example, if the application component determines, according to the location information of the user, two application partitions existing in the second application, namely, an application partition A and an application partition B, the application component may select a suitable application partition as the application partition of the user in the second application according to a current density of the application partition A, a current density of the application partition B, and a preset density threshold. The density threshold may include, but is not limited to, at least one of an upper limit threshold and a lower limit threshold. This is not particularly limited in this embodiment.

It may be understood that the application component may set or adjust the density threshold of the application partition of the second application according to application information of the second application, for example, an application type of the second application, and customized requirement configuration information of the second application. This is not particularly limited in this embodiment.

If neither the current density of the application partition A nor the current density of the application partition B exceeds the preset upper limit threshold, the application component may select an application partition with a smaller current density as the application partition of the user in the second application.

If the current density of one application partition, such as the application partition A, exceeds the preset upper limit threshold, the application component may select another application partition, such as the application partition B, as the application partition of the user in the second application.

As the number of users gradually increases, densities of some application partitions may be excessively high, resulting in an excessively large amount of user access to application servers deployed in such application partitions, or even possibly resulting in crashes of the application servers. In this case, the application component may further adjust coverage ranges of the application partition and other application partitions in the second application according to a preset density threshold of an application partition. The density threshold may include, but is not limited to, at least one of an upper limit threshold and a lower limit threshold. This is not particularly limited in this embodiment.

In this way, a user quantity of each application partition is controlled by adjusting the coverage ranges of the application partitions. This may effectively improve the reliability of the application server.

It may be understood that the application component may set or adjust the density threshold of the application partition of the second application according to application information of the second application, for example, an application type of the second application, and customized requirement configuration information of the second application. This is not particularly limited in this embodiment.

In a specific implementation process, if a current density of an application partition is greater than or equal to the preset upper limit threshold of the application partition, the application component may expand the coverage range of the application partition to achieve a suitable partition density.

In another specific implementation process, if a current density of an application partition identity is less than or equal to the preset lower limit threshold of the application partition, the application component may reduce the coverage range of the application partition to achieve a suitable partition density.

In this embodiment, the application component obtains the location information of the user from the first application, and then obtains the application partition of the user in the second application according to the location information of the user, so that the application component may associate the user to the application partition, thereby implementing the application partition of the user.

In addition, by using the technical solutions provided in the present application, the application component and the second application are independent of each other, so that the application component is portable and may be conveniently applied to the second application, thereby improving the universality of running of the application component.

In addition, by using the technical solutions provided in the present application, the application component and the second application are independent of each other, so that the application component can implement application partitions of users for different second applications, and it is unnecessary to configure an application component independently for each second application, thereby effectively reducing development costs of the second application.

In addition, by using the technical solutions provided in the present application, the application component and the second application are independent of each other, so that the application component can implement application partitions of users for different second applications, set different application partitioning methods for different second applications, and guide user traffic into the application partitions.

In addition, by using the technical solutions provided in the present application, users are allocated to different application partitions, so that the users obtain better user experience. For example, offline interaction relationships are transplanted to online interactions (people familiar with each other in the same place can play games together). Alternatively, in another example, offline interactions are developed through online geographic relevance (nearby people unfamiliar with each other may communicate offline by playing games), to enhance online and offline social experience of the users, and improve user experience of games or applications having social and multi-person interaction attributes, such as board games, and team battle games.

It should be noted that, for ease of description, the foregoing method embodiments are represented as a series of action combinations, but a person skilled in the art should appreciate that the present application is not limited to the described order of actions because some steps may be performed in another order or performed simultaneously according to the present application. In addition, it should also be appreciated by a person skilled in the art that all the embodiments described in the specification are preferred embodiments, and the related actions and modules are not necessarily mandatory to the present application.

In the foregoing embodiments, description of each embodiment focuses on a different part, and for parts that are not described in detail in one embodiment, reference may be made to the related description of other embodiments.

FIG. 2 is a block diagram of an example of a computer system/server 12 suitable for implementation of the present application. The computer system/server 12 displayed in FIG. 2 is merely an example, and should not limit the functions and usage scope of the embodiments of the present application in any manner.

As shown in FIG. 2, the computer system/server 12 is represented in a form of a computing device. Components of the computer system/server 12 may include, but is not limited to: one or more processors or processing units 16, a storage apparatus or a system memory 28, and a bus 18 connecting different system components (which include the system memory 28 and the processing unit 16).

The bus 18 indicates one or more of several types of bus structures, including a memory bus or memory controller, a peripheral bus, an accelerated graphics port, a processor, or a local bus using any of a plurality of bus architectures. For example, the architectures include, but are not limited to, an industrial standard architecture (ISA) bus, a micro channel architecture (MCA) bus, an enhanced ISA bus, a video electronics standards association (VESA) local bus, and a peripheral component interconnection (PCI) bus.

The computer system/the server 12 typically includes various computer system readable media. The media may be any available media accessible to the computer system/server 12, including volatile and nonvolatile media, removable and non-removable media.

The system memory 28 may include a computer system readable medium in a form of a volatile memory, for example, a random access memory (RAM) 30 and/or a cache memory 32. The computer system/server 12 may further include other removable and non-removable, volatile and nonvolatile computer system storage media. Merely used as an example, a storage system 34 may be configured to read from or write to a non-removable nonvolatile magnetic medium (not shown in FIG. 2, generally referred to as a “hard disk drive”). Although not shown in FIG. 2, a magnetic disk drive configured to read from or write to a removable nonvolatile magnetic disk (for example, “a floppy disk”), and an optical drive configured to read from or write to a removable nonvolatile optical disc (for example, a compact disc read-only memory (CD-ROM), a DVD-ROM, or another medium) may be provided. In such cases, each drive may be connected to the bus 18 through one or more data medium interfaces. The system memory 28 may include at least one program product. The program product includes a set of (for example, at least one) program modules. The program modules are configured to implement functions of the foregoing embodiments in the present application.

A program/practical tool 40 including a set of (at least one) program modules 42 may be stored, for example, in the system memory 28. Such program modules 42 include, but are not limited to, an operating system, one or more applications, other program modules, and program data. Each of such examples or a combination thereof may include an implementation of a network environment. The program modules 42 generally implement the functions/methods described in the embodiments of the present application.

The computer system/server 12 may further communicate with one or more external devices 14 (for example, a keyboard, a pointing device, or a display 24), or may communicate with one or more devices enabling a user to interact with the computer system/server 12, and/or may communicate with any device (for example, a network card, or a modem) enabling the computer system/server 12 to communicate with one or more other computing devices. Such communication may be performed by using an input/output (I/O) interface 44. In addition, the computer system/server 12 may further communicate with one or more networks (for example, a local area network (LAN), a wide area network (WAN), and/or a public network such as the Internet) through a network adapter 20. As shown in the figure, the network adapter 20 communicates with other modules of the computer system/server 12 through the bus 18. It should be understood that although not shown in the figure, other hardware and/or software modules may be used in combination with the computer system/server 12, including, but not limited to microcode, a device drive, a redundancy processing unit, an external disk drive array, a RAID system, a tape drive, a data backup and storage system, or the like.

The processing unit 16 runs programs stored in the system memory 28 to execute various functional applications and data processing, for example, to perform the application partition processing method provided in any one of the embodiments corresponding to FIG. 1 to FIG. 3.

In another embodiment of the present application, a computer-readable storage medium is further provided, storing a computer program. The application partition processing method provided in the embodiment corresponding to FIG. 1 is performed when the program is executed by a processor.

Specifically, any combination of one or more computer-readable media may be used. The computer-readable medium may be a computer-readable signal medium or a computer-readable storage medium. The computer-readable storage medium may be, for example, but is not limited to, an electrical, magnetic, optical, electromagnetic, infrared, or semiconductor system, apparatus, or device, or any combination thereof. More specific examples of the computer-readable storage medium (a non-exhaustive list) include: an electrical connection having one or more wires, a portable disk, a hard disk, a RAM, a ROM, an erasable programmable ROM (EPROM or a flash memory), an optical fiber, a CD-ROM, an optical storage device, a magnetic storage device, or any appropriate combination thereof. In this application, the computer-readable storage medium may be any tangible medium including or storing a program, and the program may be used by or used in combination with an instruction execution system, an apparatus, or a device.

The computer-readable signal medium may include a data signal being in a baseband or propagated as a part of a carrier, the data signal carrying computer-readable program code. The propagated data signal may be in a plurality of forms, including but not limited to, an electromagnetic signal, an optical signal, or any appropriate combination thereof. The computer-readable signal medium may alternatively be any computer-readable medium other than the computer-readable storage medium. The computer-readable medium may send, propagate or transmit a program for use by or in combination with an instruction execution system, apparatus or device.

The program code contained in the computer-readable medium may be transmitted by using any appropriate medium, including but not limited to: a wireless medium, a wire, an optical cable, RF, any suitable combination of the above, or the like.

Computer program code used for performing the operations in the present application may be written by using one or more programming languages or a combination thereof. The programming language includes an object-oriented programming language such as Java, Smalltalk, C++, and a conventional procedural programming language such as “C” language or a similar programming language. The program code may be executed entirely on a computer of a user, partly on the computer of the user, as a stand-alone software package, partly on the computer of the user and partly on a remote computer, or entirely on the remote computer or a server. For the case involving a remote computer, the remote computer may be connected to a computer of a user through any type of network including a LAN or a WAN, or may be connected to an external computer (for example, through the Internet by using an Internet service provider).

A person skilled in the art can clearly understand that for convenience and conciseness of description, the specific working processes of the above-described systems, apparatuses and units can be understood with reference to the corresponding processes in the above-described method embodiments and will not be repeated here.

In the several embodiments provided in the present application, it should be understood that the disclosed system, apparatus, and method may be implemented in other manners. For example, the apparatus embodiments described above are only schematic. For example, the division of the units is only a logic function division. In actual implementation, there may be other division manners. For instance, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may or may not be physically separated, and the components displayed as units may or may not be physical units, that is, may be located in one place or may be distributed over multiple network units. Some or all of the units may be selected according to actual requirements to achieve the objectives of the solutions in the embodiments.

In addition, functional units in the embodiments of the present application may be integrated into one processing unit, or each of the units may exist alone physically, or two or more units may be integrated into one unit. The integrated unit may be implemented in a form of hardware, or may be implemented in a form of hardware in addition to a software functional unit.

The foregoing integrated unit implemented in a form of a software functional unit may be stored in a computer-readable storage medium. The software functional unit is stored in a storage medium and includes several instructions for instructing a computer device (which may be a personal computer, a server, a network device, or the like) or a processor to perform some of the steps of the methods described in the embodiments of the present application. The foregoing storage medium includes any medium that may store program code, such as a USB flash drive, a removable hard disk, a ROM, a RAM, a magnetic disk, or an optical disc.

Finally, it should be noted that the foregoing embodiments are merely intended for describing the technical solutions of the present application but not for limiting the present application. Although the present application is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present application.

What is claimed is:

1. An application partition processing method, comprising:
obtaining, by an application component, location information of a user from a first application;
obtaining, by the application component, an application partition of the user in a second application according to the location information of the user; and
associating, by the application component, the user to the application partition.

2. The method according to claim 1, further comprising:
obtaining, by the first application, an invoking instruction triggered by the user for the second application; and
triggering, by the first application, running of the second application according to the invoking instruction.

3. The method according to claim 1, wherein before obtaining, by the application component, the location information of the user from the first application, the method further comprises:
obtaining, by the first application, wireless access point information of a wireless access point to which a terminal is connected, wherein the first application is located at the terminal;
obtaining, by the first application, location information of the wireless access point according to the wireless access point information; and
providing, by the first application, the location information of the wireless access point to the application component, so that the application component determines the location information of the user according to the location information of the wireless access point.

4. The method according to claim 3, wherein obtaining, by the application component, location information of the user from the first application comprises:
using, by the application component, the location information of the wireless access point as the location information of the user.

5. The method according to claim 1, wherein before obtaining, by the application component, the location information of the user from the first application, the method further comprises:
obtaining, by the first application, location information of a terminal, wherein the first application is located at the terminal; and
providing, by the first application, the location information of the terminal to the application component, so that the application component determines the location information of the user according to the location information of the terminal.

6. The method according to claim 1, wherein the step of obtaining, by the application component, the application partition of the user in the second application according to the location information of the user, comprises:
creating, by the application component, a new application partition in the second application as the application partition of the user in the second application according to the location information of the user when a location corresponding to the location information of the user does not belong to any application partition existing in the second application; and
obtaining, by the application component, an existing application partition in the second application as the application partition of the user in the second application through matching according to the location information of the user when the location corresponding to the location information of the user belongs to the existing application partition in the second application.

7. The method according to claim 6, wherein the step of obtaining, by the application component, the existing application partition in the second application as the application partition of the user in the second application through matching according to the location information of the user, comprises:
determining, by the application component according to the location information of the user, at least two existing application partitions existing in the second application covering the location information of the user; and
obtaining, by the application component, the existing application partition as the application partition of the user in the second application through matching according to a current density of each application partition in the at least two existing application partitions.

8. The method according to claim 1, further comprising:
adjusting, by the application component, coverage ranges of the application partition and other application partitions in the second application according to a preset density threshold of the application partition.

9. The method according to claim 1, wherein
the application component and the second application are independent of each other; or
the application component is integrated with the second application.

10. The method according to claim 1, wherein
the first application and the second application are independent of each other; or
the first application is integrated with the second application; or the first application is a host application, and the second application is a hosted application.

11. A device, comprising:
one or more processors; and
a storage apparatus, configured to store one or more programs,
the one or more programs, when executed by the one or more processors, causing the one or more processors to perform the following operations:
obtaining location information of a user from a first application by using an application component;
obtaining an application partition of the user in a second application according to the location information of the user by using the application component; and
associating the user to the application partition by the application component.

12. A computer-readable storage medium, storing a computer program, when executed by one or more processors, causing the one or more processors to perform the following operations:
obtaining location information of a user from a first application by using an application component;
obtaining an application partition of the user in a second application according to the location information of the user by using the application component; and
associating the user to the application partition by the application component.
